(19) United States
(12) Patent Application Publication
(10) Pub. No.: US 2014/0038153 A1
(43) Pub. Date: Feb. 6, 2014

(54) PATIENT SIMULATING MANNEQUIN EYE MODULE

(71) Applicants: Christophe Courtoy, Boucherville (CA); Yanick Cote, Lachine (CA); Eric Charbonneau, St-Jerome (CA)

(72) Inventors: Christophe Courtoy, Boucherville (CA); Yanick Cote, Lachine (CA); Eric Charbonneau, St-Jerome (CA)

(73) Assignee: CAE HEALTHCARE CANADA INC., Saint-Laurent, QC (CA)

(21) Appl. No.: 13/990,197

(22) PCT Filed: Nov. 30, 2011
(86) PCT No.: PCT/US11/62681

§ 371 Date: Oct. 11, 2013

Related U.S. Application Data
(60) Provisional application No. 61/417,968, filed on Nov. 30, 2010.

(51) Int. Cl. G09B 23/30

(52) U.S. Cl. CPC G09B 23/30
USPC 434/271; 434/267

(57) ABSTRACT

A patient simulating mannequin has a head, at least one electronic visual display mounted to the head, and an electronic controller connected to the at least one electronic visual display. The at least one electronic visual display displays at least one of a plurality of eye images in response to a signal from the electronic controller. The plurality of eye images includes a plurality of images of pupils and at least one of iris and sclera. The plurality of images of the pupils and the at least one of iris and sclera includes images of at least one of different colors, positions and shapes of these elements. The electronic controller can control a brightness of the electronic visual display. An eye module and a method for modeling eyes of a patient simulating mannequin are also disclosed.

### CROSS-REFERENCE TO RELATED APPLICATIONS

The present application is related to U.S. provisional patent application Ser. No. 61/417,968, filed Nov. 30, 2010, entitled “Patient Simulating Mannequin Eye Module”. This application is incorporated herein by reference in its entirety.

### TECHNICAL FIELD

The present invention relates to an eye module for patient simulating mannequins used for medical training.

### BACKGROUND

Patient simulating mannequins are used in the medical field to train paramedics, nurses, and doctors to deliver first aid to injured patients. In order to simulate the traumas with greater realism, the mannequin is shaped to resemble to a human and is conceived to reproduce some of the physiological behaviours of an actual human. In some cases, the mannequin can bleed, speak, or respond to a pressure applied to it.

One of way for a trainee to assess the trauma or the degree of trauma of an actual patient is by looking at the eyes of the patient. For example, a change of color of the sclera or a dilatation of the pupil can be signs of a specific trauma.

Current mannequins are equipped with mechanical eyes. The mechanical eyes typically look in a fixed direction. Some of the mannequins, however, have eyes that can move. Sometimes the mechanical eyes are equipped with eyelids that mechanically open and close onto the eyes. In some cases, the eyes have pupils that can be dilated or retracted mechanically.

The eyes of a patient simulator as they are currently constructed limit the number of trauma indicators a mannequin can simulate. For example, the change of color of the sclera or the pupil cannot be modeled. Because the eyes are constructed mechanically, subtle variations in color, size and positions of the elements constituting the eyes, or the eyelids, cannot be modeled.

Furthermore, when simulating some of the traumas, the state of the eyes changes over time. For example, the patient can have eyes indicating a healthy condition, and as the simulation scenario runs, his/her state degrades and the eyes should then display a trauma condition. The current mannequins do not have (or have limited) correlation between the state of health of the patient and the simulated eye. For example, the eyelids do not close as the patient loses consciousness.

Finally, the current eyes of the mannequins are not easily removable from the mannequins when these need to be changed or repaired.

Therefore, there is a need for a mannequin having eyes that model different traumas.

There is also a need for a mannequin that has eyes (and optionally eyelids) changing as the simulated health of the patient is changing.

Finally, there is also a need for an eye module that can be easily removable from the mannequin such that the eyes (and optionally eyelids) can be replaced at the convenience of the user.

### SUMMARY

It is an object of the present invention to ameliorate at least some of the inconveniences present in the prior art.

It is also an object of the present invention to provide a patient simulating mannequin. The patient simulating mannequin comprises a head, at least one electronic visual display mounted to the head, and an electronic controller connected to the at least one electronic visual display. The at least one electronic visual display displays at least one of a plurality of eye and eyelid images in response to a signal from the electronic controller.

In an additional aspect, the at least one electronic visual display includes at least one of an Organic Light-Emitting Diode (OLED) and a Liquid Crystal Display (LCD) screen.

In a further aspect, the electronic controller controls a display of the plurality of eye and eyelid images on the at least one electronic visual display. The plurality of eye and eyelid images includes at least one of images of eyes and eyelids of different colors, positions and shapes.

In an additional aspect, the plurality of eye and eyelid images includes images of pupils, iris and sclera of at least one of different colors, positions and shapes.

In a further aspect, the electronic controller controls a brightness of the electronic visual display.

In an additional aspect, the at least one electronic visual display includes a left electronic visual display and a right electronic visual display. The left electronic visual display displays at least one of a plurality of left eye and eyelid images. The right electronic visual display displays at least one of a plurality of right eye and eyelid images.

In a further aspect, the plurality of eye and eyelid images is a plurality of sequentially displayed images producing an animation.

It is also an object to provide a patient simulating mannequin. The patient simulating mannequin comprises a head, at least one electronic visual display mounted to the head, and an electronic controller connected to the at least one electronic visual display. The at least one electronic visual display displays at least one of a plurality of eye images in response to a signal from the electronic controller. The plurality of eye images includes a plurality of images of pupils and at least one of iris and sclera. The plurality of images of the pupils and the at least one of iris and sclera includes images of at least one of different colors, positions and shapes.

In an additional aspect, the electronic controller controls a brightness of a display of the plurality of eye images.

In a further aspect, the at least one electronic visual display includes at least one of an Organic Light-Emitting Diode (OLED) and a Liquid Crystal Display (LCD) screen.

In an additional aspect, the electronic controller controls a display of the plurality of eye images on the at least one electronic visual display based on at least one of a modeled physiological state of the patient simulating mannequin, a location of a trainee relative to the patient simulating mannequin, and an intensity of ambient light.

In a further aspect, at least one sensor senses at least one of the location of a trainee relative to the patient simulating mannequin and the intensity of ambient light. The at least one sensor is connected to the electronic controller. The display of the plurality of eye images is updated in real time by the electronic controller based on information sent by the at least one sensor.

In an additional aspect, the mannequin further comprises at least one pressure sensor. The location of the trainee is determined based on a signal sent by the sensor. The signal is indicative of a location where pressure is applied to the mannequin by the trainee.

In a further aspect, the at least one pressure sensor is located in an upper portion of an arm of the mannequin.

In an additional aspect, the mannequin further comprises at least one light sensor. The at least one light sensor sends out information about an intensity of ambient light.

In a further aspect, the at least one light sensor is located on the head of the mannequin proximate to the at least one electronic visual display.

In an additional aspect, the at least one of the plurality of eye images is a plurality of sequentially displayed images producing an animation.

In a further aspect, at least one memory storage device is connected to the electronic controller. The at least one memory storage device stores the plurality of eye images.

In an additional aspect, the at least one memory storage device is located proximate to the at least one electronic visual display.

In a further aspect, the plurality of eye images includes at least a plurality of healthy eye images and a plurality of eye images presenting a trauma.

In an additional aspect, the at least one electronic visual display includes a left electronic visual display and a right electronic visual display. The at least one of the plurality of eye images includes at least one of a plurality of left eye images and at least one of a plurality of right eye images. The left electronic visual display displays the at least one of the plurality of left eye images. The right electronic visual display displays the at least one of the plurality of right eye images.

In a further aspect, the at least one of the plurality of left eye images displayed by the left electronic visual display is different from the at least one of the plurality of right eye images displayed by the right electronic visual display.

In an additional aspect, at least one cover encloses at least partially the at least one electronic visual display. The at least one electronic visual display is connected to the at least one cover.

In a further aspect, at least one memory storage device is connected to the electronic controller. The at least one memory storage device stores the plurality of eye images. The at least one memory storage device is removably connected to the cover. The at least one cover together with the at least one electronic visual display and the at least one memory storage device connected thereto, is removable from the patient simulating mannequin.

In an additional aspect, the at least one cover provides at least in part a water resistant enclosure for the at least one electronic visual display.

In a further aspect, the at least one cover, with the at least one electronic visual display connected thereto, is removable from the patient simulating mannequin.

In an additional aspect, the at least one cover includes at least one aperture. The at least one electronic visual display is at least partially visible though the at least one aperture.

In an additional aspect, the at least one electronic visual display includes a left electronic visual display and a right electronic visual display. The at least one aperture includes a left aperture and a right aperture. The left electronic visual display is at least partially visible through the left aperture. The left electronic visual display displays at least one of a plurality of left eye images. The right electronic visual display is at least partially visible through the right aperture. The right electronic visual display displays at least one of a plurality of right eye images.

In a further aspect, the at least one cover is shaped as a facial mask.

In an additional aspect, the head comprises a skull and a skin. The skull provides a structural frame of the head. The at least one cover is removably connected to the skull. The skin is disposed at least partially over the at least one cover.

In a further aspect, the skin includes left and right apertures. When disposed over the at least one cover, a portion of the left and right electronic visual displays is visible through the left and right apertures.

In an additional aspect, left and right see-through inserts are disposed at the left and right apertures of the skin. The left and right see-through inserts allow to see the left and right electronic visual displays through the left and right apertures of the skin. The skin and the left and right see-through inserts provide at least in part a water resistant enclosure for the left and right electronic visual displays.

In a further aspect, the plurality of eye images includes a plurality of eye and eyelid images.

In an additional aspect, the plurality of eye and eyelid images includes images of different eyelid positions.

It is also an object to provide a removable eye module for a patient simulating mannequin. The eye module comprises at least one electronic visual display displaying a plurality of eye images, and at least one cover. The at least one electronic visual display is connected to the at least one cover. The at least one cover covers at least partially the at least one electronic visual display. The at least one electronic visual display is at least partially visible through the at least one cover. The at least one cover together with the at least one electronic visual display connected thereto is adapted to be removably connected to the patient simulating mannequin.

In a further aspect, the at least one cover includes at least one aperture. The at least one electronic visual display is at least partially visible through the at least one aperture.

In an additional aspect, the at least one electronic visual display includes a left electronic visual display and a right electronic visual display. The left electronic visual display displays a plurality of left eye images. The right electronic visual display displays a plurality of right eye images. The at least one cover includes left and right apertures. The left electronic visual displays is at least partially visible though the left aperture. The right electronic visual displays is at least partially visible though the right aperture.

In a further aspect, the at least one cover is shaped as a facial mask.

In an additional aspect, the plurality of eye images includes at least one of images of eyes of different colors, positions and shapes.

In a further aspect, the plurality of eye images includes images of pupils, iris and sclera of at least one of different colors, positions and shapes.

In an additional aspect, the electronic controller controls a brightness of the electronic visual display.

In a further aspect, the at least one electronic visual display is adapted to be connected to an electronic controller. A display of a plurality of eye images on the at least one electronic visual display is adapted to be controlled by the electronic controller.

In an additional aspect, at least one memory storage device is connected to the at least one electronic visual display. The at least one memory storage device stores the plurality of eye images.

In a further aspect, the plurality of eye images includes a plurality of eye and eyelid images.

In an additional aspect, the plurality of eye and eyelid images includes images of different eyelid positions.

It is also an object to provide a method for modeling at least one eye of a patient simulating mannequin. The method comprises determining an eye state control parameter of the patient simulating mannequin. The eye state control parameter is at least one of a modeled physiological state of the patient simulating mannequin, a location of a trainee relative to the patient simulating mannequin, and an intensity of ambient light. The method comprises displaying at least one image of the at least one eye on at least one electronic visual display based on the eye state control parameter; and displaying at least one other image of the at least one eye on the at least one electronic visual display based on at least a change of the eye state control parameter.

In a further aspect, the at least one electronic visual display includes a left electronic visual display and a right electronic visual display. The at least one eye includes a left eye and a right eye. The left electronic visual display displays images of the left eye. The right electronic visual display displays images of the right eye.

In an additional aspect, displaying at least one image of at least one eye includes displaying at least one image of at least one of a pupil, an iris and a sclera of the at least one eye; and displaying at least one other image of the at least one eye includes displaying the at least one of the pupil, iris and sclera of at least one of a different color, position and shape relative to the image of the at least one eye.

In a further aspect, the at least one image of the at least one eye and the at least one other image of the at least one eye include at least a plurality of healthy eye images and a plurality of eye images displaying a trauma.

In an additional aspect, the at least one image of the at least one eye includes at least one image of at least one eye and eyelid.

In a further aspect, the at least one image of eye and eyelid includes images of different eyelid positions.

It is yet another object to provide a patient simulating mannequin comprising a head. At least one electronic visual display is mounted to the head. At least one light sensor sends information on an intensity of ambient light. An electronic controller is connected to the at least one electronic visual display. The at least one electronic visual display is displaying at least one of a plurality of eye images in response to a signal from the electronic controller. The electronic controller is controlling a brightness of the electronic visual display based on the information sent by the at least one light sensor.

In a further aspect, the at least one light sensor is located proximate to eyes of the patient simulating mannequin.

In an additional aspect, the at least one electronic visual display further displays at least one of a plurality of eyelid images in response to a signal from the electronic controller.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1A is a bottom perspective view of a front of a patient simulating mannequin;

FIG. 1B illustrates skin being applied to a structural skeleton of the mannequin of FIG. 1A;

FIG. 2A is a picture taken from a front side of legs having a trauma which can be connected to the mannequin of FIG. 1A;

FIG. 2B is a picture taken from a top, left perspective of the legs of FIG. 2B;

FIG. 3A is a front elevation view of the structural skeleton and various components of the mannequin of FIG. 1A;

FIG. 3B is a left side elevation view of the structural skeleton and various components of the mannequin of FIG. 1A;

FIG. 4 is a front elevation view of an eye module of the mannequin of FIG. 1A;

FIG. 5 is a rear elevation view of the eye module of FIG. 4;

FIG. 6 is a perspective view taken from a front, right side of a head of the mannequin of FIG. 1A with the skin removed;

FIG. 7 is a front view of the head of the mannequin of FIG. 1A;

FIGS. 8A to 8E are examples of images displayed on a left screen of the eye module of FIG. 4; and

FIG. 9 is a flow chart of a method for modeling an eye of the mannequin of FIG. 1A.

### DETAILED DESCRIPTION

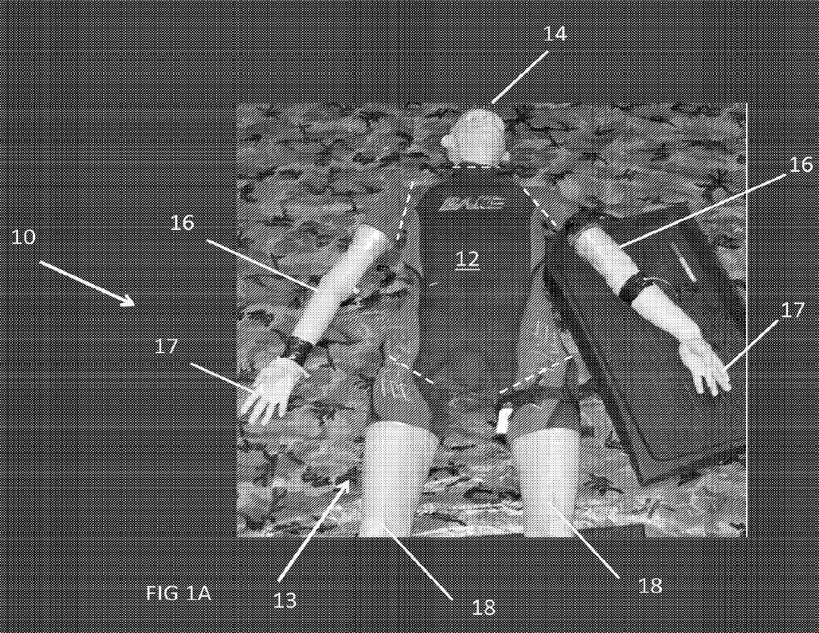

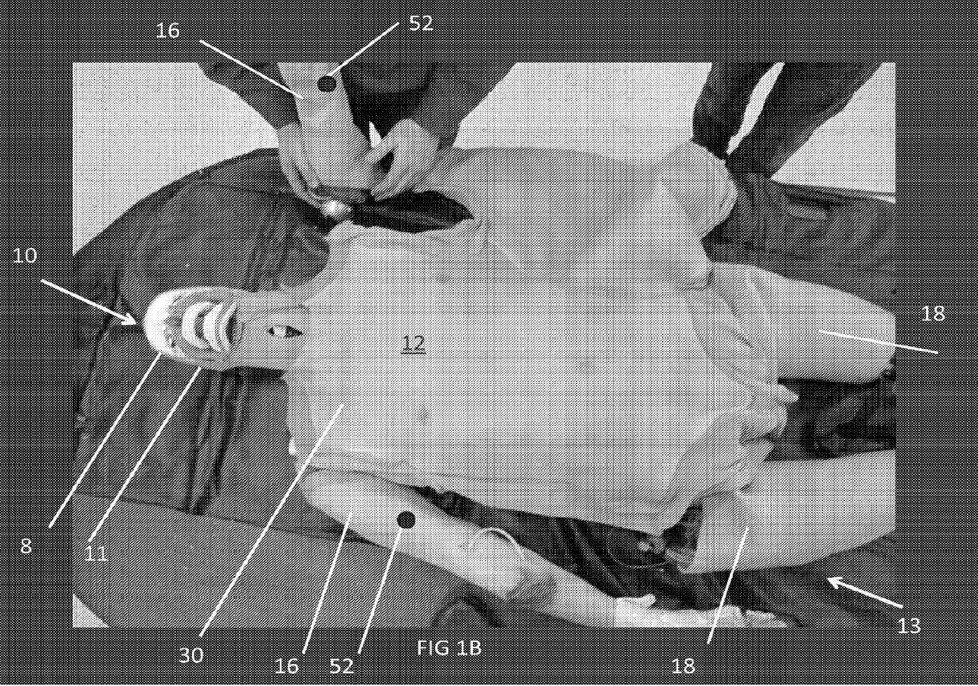

A mannequin 10 is illustrated in FIGS. 1A and 1B. The mannequin 10 is a patient simulating mannequin and is used as a medical training tool for paramedics, nurses, field medics and doctors when training for first aid delivery to injured patients. As will be described below, the mannequin 10 is adaptable to different trauma situations, thus providing a variety of scenarios to trainees. It is contemplated that the mannequin 10 could have uses other than those recited above, and that the mannequin 10 could be used by persons other than those of the medical field.

The mannequin 10 is a generally anatomically correct representation of an adult male. The mannequin measures 183 cm (6 feet) and weights between 68 and 79 kg (between 150 pounds and 174 pounds). The weight is distributed throughout the mannequin 10 in a manner similar to that of an actual adult male. For example, the forearm of the mannequin 10 weights about the same as the forearm of an actual adult male of the same size. It is contemplated that the mannequin 10 could be a female, a teenager, a child, or a senior. It is also contemplated that the mannequin 10 could be outside the measurements provided above.

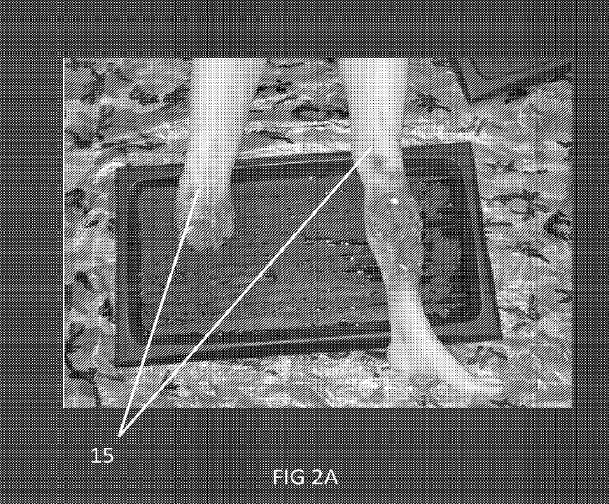

The mannequin 10 has a torso 12, a head 14, and limbs 13. The limbs 13 include left and right arms 16, and left and right legs 18. The left and right arms 16 include left and right hands 17, and the left and right legs 18 include left and right feet 19 (only the left foot being shown in FIGS. 2A and 2B). The mannequin 10 has a structural skeleton 20 and is wrapped with a skin 30 (best seen in FIG. 1B). The skeleton 20 provides a structural frame to the mannequin 10, but also provides support to some of the electrical components and other systems of the mannequin 10. The skin 30 is an envelope to the mannequin 10. Each limb 13 is covered by a single piece of skin 30. The skin 30 is made of silicone which is flexible and has a feel and color resembling to that of the human skin. The skin 30 can be made of any color. The feet 19, hands 17 and head 14 are wrapped with skin 11 (made of silicone) that is sturdier than that of the torso 12, arms 16 and legs 18, since these parts are more likely to rub against surfaces when the mannequin 10 is displaced. Some portions of the mannequin 10, such as the limbs 13 contain a silicone filling (not shown) over which the skin 30 is disposed. The silicone filling provides the feel of human flesh and/or muscles when touched. It is contemplated that several skin pieces could be used to cover each limb 13. It is contemplated that the skin 30, the skin 11 and the filling could be made of materials other than silicone. The skeleton 20 will be described below.

The head 14 and the limbs 13 are each removable from the torso 12. The limbs 13 are replaceable by trauma limbs 15. The trauma limbs are shown in FIGS. 2A and 2B. A trauma limb 15 is a limb designed to simulate an injury. Examples of injuries are open wounds, burns, or partially or entirely amputated limbs. The trauma limbs 15 visually represent actual wounds for increased reality during a training session. They have similar color, shape and texture to that of actual wounds. To ensure a realistic simulation of a trauma, the mannequin 10 is equipped with a circulatory system (not shown) which is designed to allow blood to flow out of the trauma limbs 15. It is contemplated that only some of the left and right arms 16, and the left and right legs 18 could be replaceable by trauma limbs 15. It is also contemplated that only a portion of the left and right arms 16, and the left and right legs 18 could be replaceable by trauma limbs 15. For example, only a hand 17 or only a foot 19 could be detachable from a rest of the mannequin 10 and be replaceable by a trauma hand or foot. It is contemplated that the head 14 could be replaceable by a trauma head. It is also contemplated that the mannequin 10 could have other parts replaceable by trauma limbs depending on the training purpose.

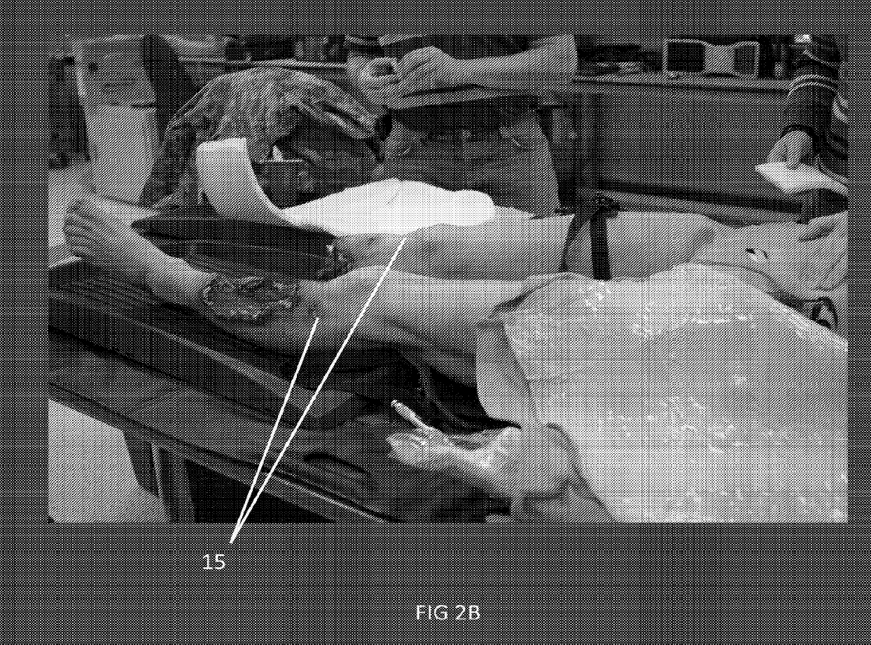

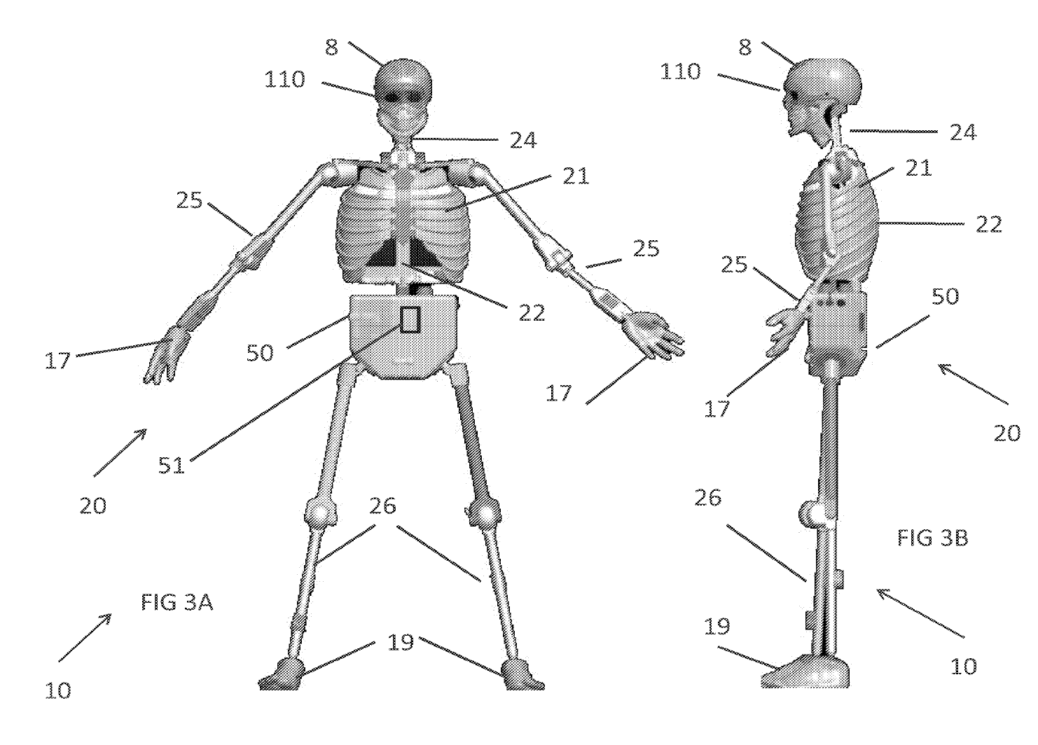

Referring now to FIGS. 3A and 3B, the skeleton 20 comprises a rib cage 21, a spinal structural member 22, a neck 24, left and right articulated arms 25, and left and right articulated legs 26. A skull 8 is connected to the neck 24 and provides a structural frame to the head 14. The left and right articulated arms 25 are articulated at the shoulders, elbows and wrists. The left and right articulated legs 26 are articulated at the hips, knees, and ankles. The left and right articulated legs 26 are connected to the spine 22 via a pelvic structural member in the form of a structural control box 50. The control box 50 acts as a structural part to the mannequin 10 similar to a pelvis, and protects the electronic controls of the mannequin 10. The control box 50 includes an electronic controller 51 (shown schematically in FIG. 3A). The electronic controller controls various aspect of the mannequin's 10 behaviour. Some of these aspects will be described below with respect to eyes of the mannequin 10. The spinal structural member 22, the neck 24, the left and right articulated arms 25, and the left and right articulated legs 26 are made of aluminum. The skull 8 is made of urethane. It is contemplated that the spinal structural member 22, the neck 24, the left and right articulated arms 25, and the left and right articulated legs 26 could be made of other material, such as urethane.

The rib cage 21 is made of flexible urethane. The spinal structural member 22, the neck 24, the left and right arms 25, and the left and right legs 26 are made of several pieces which provide the mannequin 10 with an articulated motion and range of motion similar to that of an average young adult. It is contemplated that the rib cage 21 could be made of other flexible material, such as polyurethane.

The mannequin 10 is provided with multiple simulated physiological systems which interact with each other to provide a realistic simulation of a human patient. These include, but are not limited to, at least some of a pulse system, a voice system, an eye module, and a breathing system. These systems, when interacting with each other, provide physiological responses to traumas and treatments. In one embodiment, the mannequin 10 can be controlled wirelessly by an instructor, and physiological responses occur autonomously. The physiological responses include, but are not limited to, at least some of bleeding, change of heart beat, change of eye color, or change of breathing pattern. It is contemplated that, the mannequin 10 could be wired, and that the physiological responses could be controlled by one or more instructors.

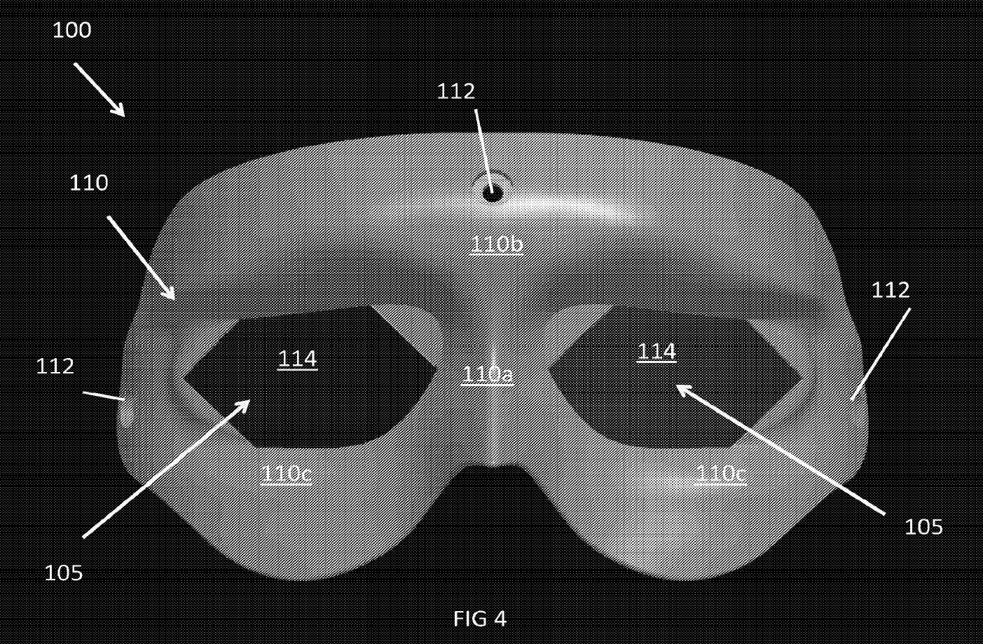

Turning now to FIGS. 4 to 7, an eye module 100 for the mannequin 10 will now be described.

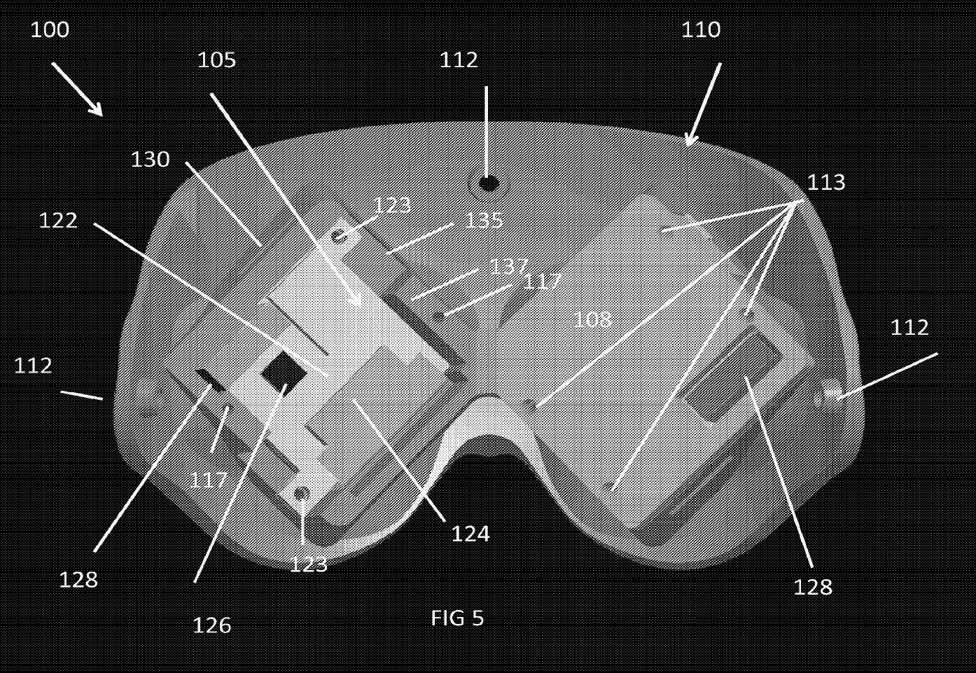

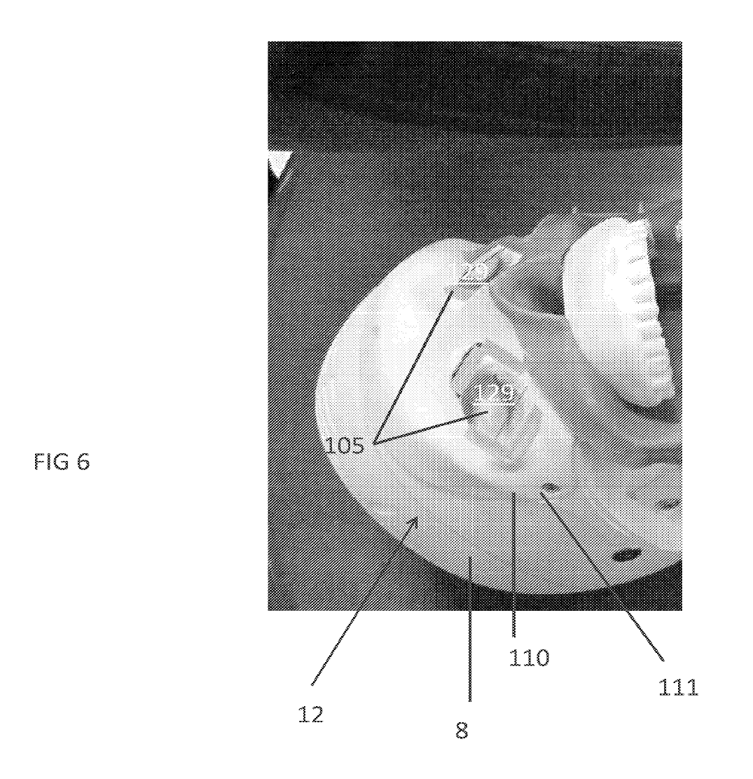

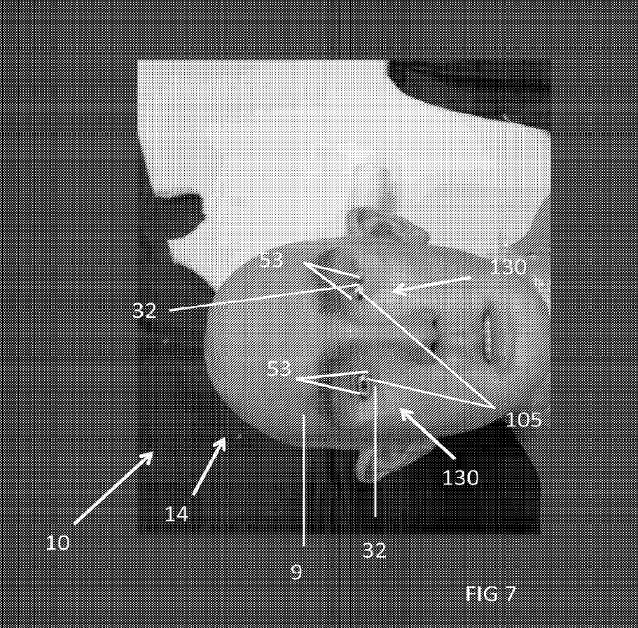

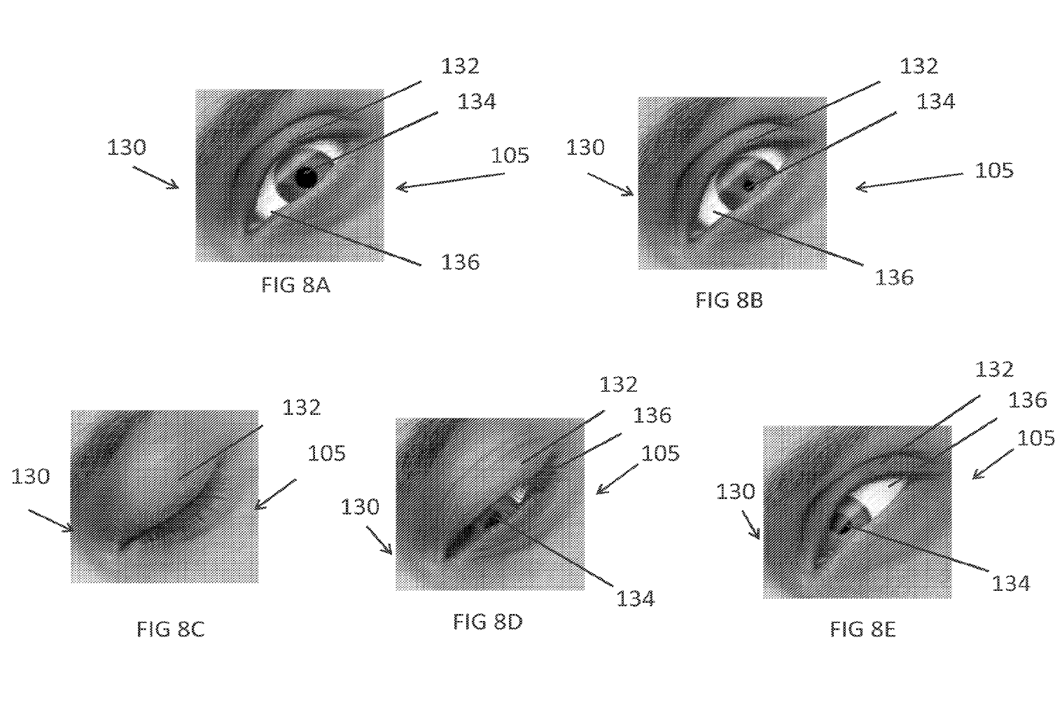

The eye module 100 is a removable component of the head 14, which models eyes of the mannequin 10. The eye module 100 includes a pair of electronic visual displays or screens 105 and a cover or mask 110. The pair of screens 105 display images of the eyes 130 and eyelids 132 (shown in FIG. 8A-8E) of the mannequin 10. The mask 110 connects the pair of screen 105 to the head 14. The mask 110 together with the pair of screens 105 is removable from the head 14, and can be easily replaced if one of the components of the eye module 100 requires replacement. A face skin 9 is disposed on top of the skull 8 and a portion of the mask 110. The face skin 9 has two apertures 32 (shown in FIG. 7) through which a portion of the screens 105 is visible. The two apertures 32 are shaped to simulate left and right eye orbits. The two apertures 32 are sized to show the eyes 130 and eyelids 132. The face skin 9 is made of the same material as the skin 30, and is easily removable by opening a zipper (not shown) located at a back of the head 14. Left and right see-through inserts 129 (shown in FIG. 6) are disposed on the apertures 32 so as to protect the screens 105 from water and other exterior elements. The see-through inserts 129 are made of a transparent polymer. The see-through inserts 129 are contacting their corresponding screen 105. It is contemplated that the face skin 9 could be made of a material different from the one of the skin 30. It is also contemplated that the skin 30 of the head 14 could be removable via laces or Velcro®. It is also contemplated that the eye module 100 could have only one or more than two screens 105. It is contemplated that the apertures 32 could have a shape different from the one shown in the Figures. For example the apertures 32 could be sized to show images of eyebrows. It is contemplated that the see-through inserts 129 could be disposed between the mask 110 and the screens 105. It is also contemplated that the see-through inserts 129 could be disposed the between an interior of the skin 30 and the mask 110. It is also contemplated that the see-through inserts 129 could be made of a material other than a polymer. For example, the see-through inserts 129 could be made of glass. It is contemplated that a space could exist between the see-through inserts 129 and their corresponding screen 105. It is contemplated that the see-through inserts 129 could be omitted.

Referring more specifically to FIG. 4, the mask 110 has a shape of a portion of a face of the mannequin 10. The mask 110 includes a nose curvature 110a, a forehead curvature 110b and eye socket curvatures 110c. The mask 110 is made of urethane, which is the same material as the skull 8. It is contemplated that the mask 110 could be made of a material different from urethane. It is also contemplated that the mask 110 could have a shape different from the one shown in the Figures. For example, the mask 110 could cover more or less of the face of the mannequin 10.

The mask 110 has two apertures 114 (left and right), each revealing a portion of a corresponding screen 105 (left and right), so that the eyes 130 displayed on the screens 105 can be seen through the apertures 114. The apertures 114 are also shaped to have a portion of the screens 105 abutting against a contour of the apertures 114. It is contemplated that the contour of the apertures 114 could have a shape of an eye socket. It is contemplated that the screens 105 could be entirely visible through the apertures 114. The apertures 114 are larger than the apertures 32. When the face skin 9 is disposed on the head 14 with the mask 110, the apertures 114 are partially covered by the face skin 9 (as shown in FIG. 7). It is contemplated that the apertures 114 could be of a same size as the apertures 32.

The mask 110 includes three anchor points 112 in the form of holes which each receives a bolt 111 (shown in FIG. 6) for removably mounting the mask 110 to the skull 8 of the head 14. One of the anchor points 112 is disposed on an upper part of the mask 110, and the two other anchor points 112 are disposed one on each side of the mask 110. The mask 110 is bolted by the bolts 111 to the skull 8 at the anchor points 112. It is contemplated that the mask 110 could not be removable from the head 14. It is contemplated that the mask 110 could be connectable to the head 14 by means other than bolts. For example, the mask 110 could be clipped to the head 14. The mask 110 could also be secured to the head 14 via screws. It is also contemplated that less than three or more than three anchor points 112 could be used to secure the mask 110 to the head 14. It is contemplated that the anchors points 112 could be disposed somewhere else on the mask 110.

Referring more specifically to FIG. 5, a portion of a back of the mask 110 is covered by left and right cover plates 108 (only the right one being shown in FIG. 5). The left and right cover plates 108 secure the screens 105 to the mask 110. The left and right cover plates 108 have each four anchor points 113 which mate with four anchor points 117 of the mask 110 (only two being shown). A screw (not shown) is inserted in each anchor point 113 to connect to the anchor points 117 of the mask 110. As shown on a left side of FIG. 5 for the left screen 105 (the right screen 105 being the same as the left screen 105), two of the anchor points 113 are aligned with anchor points 123 of a display 122 of the screen 105, so that a common anchor point 114 can be used to secure each display 122 and its respective cover plate 108 to the mask 110. The anchor points 117 are disposed on a frame 135. The frame 135 surrounds the screen 105, and positions the screen 105 with respect to the apertures 114. The frame 135 includes ribs 137 which connect to the cover plate 108 via some of the anchor points 113. A silicone seal (not shown) is disposed between the cover plates 108 and their respective frame 135. It is contemplated that less or more than four anchor points 113 could be used. It is also contemplated that anchor points other than the anchor points 113 could be used to secure the displays 122 and the cover plates 108 to the mask 110. It is also contemplated that the cover plates 108 could be secured to the mask 110 by ways other than with screws. For example, the cover plates 108 could be clipped to the mask 110. It is contemplated that the frame 135 and the ribs 137 could be omitted. It is also contemplated that the silicone seal could be omitted. The cover plates 108 are made of urethane. It is contemplated that the cover plates 108 could be made of a material other than urethane. It is also contemplated that the cover plates 108 could have a shape different from the one shown in the figures. For example, the cover plates 108 could cover the whole back of the mask 110. It is also contemplated that a single cover plate 108 or more than two cover plates 108 could be used.

The left and right screens 105 are each an Organic Light-Emitting Diode (OLED) screen. It is contemplated that each of the screens 105 could be a Liquid Crystal Display (LCD) screen. Each of the screens 105 includes the display 122, a connector 124 to a printed board (not shown), a processor 126, and a main board connector 128. A memory card (not shown) is insertable via an opening 130 to connect with the printed board. One memory card is connected to each of the screens 105. Each of the memory cards contains a plurality of images of corresponding left and right eyes 130 and eyelids 132 in different conditions and for different positions. It is contemplated that the memory cards could contain the same images to display on the left and right screens 105. The information stored on the memory cards will be described below. Each of the memory cards is a Micro SD card of 2 Gb. It is contemplated that the memory card could have other specification than the ones recited above. It is also contemplated that the memory card could also contain one or more video. It is also contemplated that the memory cards could be placed remotely their corresponding the screen 105. For example, the memory cards could be disposed in the control box 50. The processor 126 is a 4D Labs Goldelox-GFX2. The processor 126 commands a display of an image (or a series of images or a video) depending on information coming from the main board connector 128 (which itself receives instructions from the electronic controller 51). The processor 126 controls the retrieval of the images from its corresponding memory card while the electronic controller 51 determines which images should be retrieved for display on the screens 105. The connector 124 transfers information on the image to display from the processor 126 to the screens 105. It is contemplated that a controller other than the electronic controller 51 could be used for determining which images should be retrieved for display. Selection of the images is based on an eye control parameter. The eye control parameter is one or more of (non exclusively): a simulated physiological state of the mannequin 10, a location of a trainee, and an intensity of ambient light. It is contemplated that more than one eye control parameter could be used. A method for modeling the pair of eyes 130 of the mannequin 10 based on the eye control parameter will be described below.

The simulated physiological state of the mannequin 10 is determined by a physiological algorithm which is implemented in the electronic controller 51. Various sensors and controls, disposed in the mannequin 10, collect information which allows the electronic controller 51 to determine a current simulated physiological state of the mannequin 10 based on this information. The information collected by the sensors includes some or more of (non exclusively): heart rate, blood pressure, breathing pattern, detection of a tourniquet. The simulated physiological state of the mannequin 10 is updated in real time and takes into account any change of the information collected by the various sensors. Different states of the eyes 130 of the mannequin 10 are associated with the different simulated physiological states of the mannequin 10. Thus, given the current simulated physiological state of the mannequin 10, the electronic controller 51 selects an image of the left and right eyes 130 which corresponds to this simulated physiological state. For example, if the simulated physiological state is a state of unconsciousness, the electronic controller 51 will send instruction to display an image where the eyes 130 are closed. There may be a series of images (or video) corresponding to a single simulated physiological state. For example, if the simulated physiological state is consciousness, the series of images is a sequence of images of the eyes 130 with the eyelids 132 opening and closing in a timely manner similar to the one of a human moving his/her eyelids. It is contemplated that the physiological algorithm could be implemented in another controller in connection with the electronic controller 51.

To obtain information on the location of a trainee, pressure sensors 52 (shown schematically in FIG. 1B) are located in the left and right arms 16. For example, when the trainee applies a pressure of the right arm 16 such as when applying a tourniquet, the pressure sensor 52 records this information and transmits it to the electronic controller 51. The electronic controller 51 selects an image (or a series of images in turn) of the left and right eyes 130 looking in the direction of the right arm 16, so as to simulate the mannequin 10 looking toward the trainee. It is contemplated that the pressure sensors 52 could be located elsewhere in the mannequin 10. It is also contemplated that more or less than two pressure sensors 52 could be used. It is also contemplated that information about the location of the trainee could be achieved by ways other than with pressure sensors 52. For example, the trainee could carry a beacon, which distance from the mannequin 10 could be detectable by a sensor of the mannequin 10, or could be detected by microphones.

To obtain information on the intensity of ambient light, light sensors 53 (shown in FIG. 7) are located in inner and outer corners of the left and right skin apertures 32. For example, when it is dark, the light sensors 53 record that the ambient light is low, and the electronic controller 51 sends out instructions to the processor 126, via the main board connector 128, to reduce a brightness of the screens 105. In another example, the light sensors 53 detect a strong light intensity, and the electronic controller 51 selects an image (or a series of images) of the left and right eyes 130 having a retracted pupil 134 (shown in FIG. 8B), as this may be a response to the trainee looking into the eyes 130 of the mannequin 10 with a flashlight. It is contemplated than the light sensors 53 could be located only on the inner corners or only on the outer corners of the eyes 130. It is contemplated that the light sensors 53 could be located elsewhere on the mannequin 10. It is also contemplated that less or more than four light sensors 53 could be used. It is also contemplated that the light sensors 53 could be omitted. For example, the instructor could directly control the brightness of the screens 105 via a remote control.

FIGS. 8A to 8E show examples of eye 130 and eyelids 132 images displayed by the screens 105 and corresponding to different training situations. It should be understood that the examples of FIGS. 8A-8E are representative of just some of the capabilities of the eye module 100. For example, it is possible to implement images of specific eye traumas which will look different from the healthy eyes shown in FIGS. 8A-8D. The eyes 130 in FIGS. 8A-8E are also shown to have a same color. However, the memory card contains images with eyes 130 of different colors (e.g. sclera color). Also, although eyes 130 and eyelids 132 are displayed on the screens 105 shown in FIGS. 8A-8E, it is contemplated that the screens 105 could display only the eyes 130.

FIG. 8A is an image of the left eye 130 displayed on the left screen 105, where the left eyelid 132 is open, the left eye 130 looks straight ahead, a left pupil 134 is neither dilated nor retracted, and a sclera 136 of the left eye 130 is white with normal vascularisation. This image is displayed, for example, when the mannequin 10 is in the state of consciousness and no pressure is detected on the arms 16.

FIG. 8B is an image of a left eye 130 displayed on the left screen 105, where the left eyelid 132 is open, the left eye 130 looks straight ahead, the left pupil 134 is retracted, and the sclera 136 of the left eye 130 is white with normal vascularisation. This image is displayed, for example, when the mannequin 10 is conscious and the trainee is pointing the flashlight at the left eye 130. The light sensors 56 sense the increased ambient light intensity and the electronic controller 51 send a signal to the processor 126 to display an image of the left eye 130 having left pupil 134 retracted.

FIG. 8C is an image of the left eye 130 displayed on the left screen 105, where the left eyelid 132 is closed. This image is displayed, for example, when the mannequin 10 is in a state of unconsciousness. This image can also be displayed when the mannequin 10 is conscious, such as when the left eyelid 132 is moving to simulate the natural movement made by an eyelid to humidify the left eye 130.

FIG. 8D is an image of the left eye 130 displayed on the left screen 105, where the left eyelid 132 is half open, the left eye 130 looks towards the right, the left pupil 134 is neither dilated nor retracted, and the sclera 136 is white with normal vascularisation. This situation corresponds to the mannequin 10 looking towards the trainee after the location of the trainee has been assessed by the electronic controller 51 via the right pressure sensor 52, and while the left eyelid 132 is moving to simulate the natural movement made by an eyelid to humidify the left eye 130.

FIG. 8E is an image of the left eye 130 displayed on the left screen 105, where the left eyelid 132 is open, the left eye 130 looks towards the right, the left pupil 134 is neither dilated nor refracted, and the sclera 136 shows abnormal vascularisation. This situation corresponds to the eye 130 indicating a trauma with the mannequin 10 looking towards the trainee (assuming pressure on the right arm 16 has been detected by the corresponding pressure sensor 52), and while the left eyelid 132 is open.

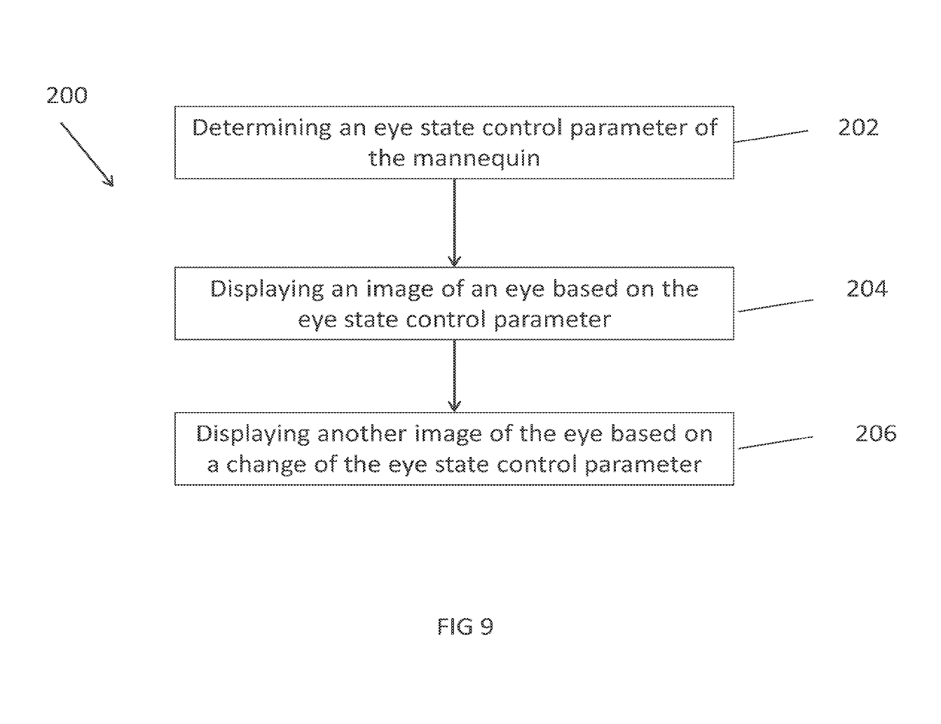

Referring now to FIG. 9, a method 200 for modeling at least one of the eyes 130 of the mannequin 10 will be described. Although the method 200 is described for one of the eyes 130, the method 200 is also implementable on the other one of the eyes 130, such that left and right eyes 130 can be modeled with the method 200.

At step 202, the eye state control parameter of the mannequin 10 is determined. As mentioned above, the electronic controller 51 determines the eye state control parameter based on information received from various sensors and controls in the mannequin 10. As mentioned above, the eye state control parameter depends on the simulated physiological state, the location of the trainee and the intensity of ambient light.

At step 204, an image of the eye 130 is displayed on a corresponding screen 105. A selection of the image is based on the eye state control parameter, and reflects a simulated physiological state of the mannequin 10.

At step 206, another image of the eye 130 and eyelid 132 is displayed on the corresponding screen 105. A selection of the other image is based on a change of the eye state control parameter.

It is contemplated that the left and right eyes 130 could not be display a same image at a same time.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

1-7. (canceled)

8. A patient simulating mannequin comprising:
a head;
at least one electronic visual display mounted to the head; and
an electronic controller connected to the at least one electronic visual display, the at least one electronic visual display displaying at least one of a plurality of eye images in response to a signal from the electronic controller, the plurality of eye images including a plurality of images of pupils and at least one of iris and sclera, the plurality of images of the pupils and the at least one of iris and sclera including images of at least one of different colors, positions and shapes.

9. The patient simulating mannequin of claim 8, wherein the electronic controller controls a brightness of a display of the plurality of eye images.

10. The patient simulating mannequin of claim 8, wherein the at least one electronic visual display includes at least one of an Organic Light-Emitting Diode (OLED) and a Liquid Crystal Display (LCD) screen.

11. The patient simulating mannequin of claim 8, wherein the electronic controller controls a display of the plurality of eye images on the at least one electronic visual display based on at least one of a modeled physiological state of the patient simulating mannequin, a location of a trainee relative to the patient simulating mannequin, and an intensity of ambient light.

12. The patient simulating mannequin of claim 11, further comprising at least one sensor sensing at least one of the location of a trainee relative to the patient simulating mannequin and the intensity of ambient light, the at least one sensor being connected to the electronic controller; and
wherein the display of the plurality of eye images is updated in real time by the electronic controller based on information sent by the at least one sensor.

13. The patient simulating mannequin of claim 12, further comprising at least one pressure sensor; and
wherein the location of the trainee is determined based on a signal sent by the sensor, the signal being indicative of a location where pressure is applied to the mannequin by the trainee.

14. (canceled)

15. The patient simulating mannequin of claim 12, further comprising at least one light sensor; and
wherein the at least one light sensor sends out information about an intensity of ambient light.

16-19. (canceled)

20. The patient simulating mannequin of claim 8, wherein the plurality of eye images includes at least a plurality of healthy eye images and a plurality of eye images presenting a trauma.

21. The patient simulating mannequin of claim 8, wherein the at least one electronic visual display includes a left electronic visual display and a right electronic visual display;
the at least one of the plurality of eye images includes at least one of a plurality of left eye images and at least one of a plurality of right eye images;
the left electronic visual display displays the at least one of the plurality of left eye images; and
the right electronic visual display displays the at least one of the plurality of right eye images.

22. The patient simulating mannequin of claim 21, wherein the at least one of the plurality of left eye images displayed by the left electronic visual display is different from the at least one of the plurality of right eye images displayed by the right electronic visual display.

23. The patient simulating mannequin of claim 8, further comprising at least one cover, the at least one cover enclosing at least partially the at least one electronic visual display, the at least one electronic visual display being connected to the at least one cover.

24. The patient simulating mannequin of claim 23, further comprising at least one memory storage device connected to the electronic controller, the at least one memory storage device storing the plurality of eye images, the at least one memory storage device being removably connected to the cover,
the at least one cover together with the at least one electronic visual display and the at least one memory storage device connected thereto, being removable from the patient simulating mannequin.

25. (canceled)

26. The patient simulating mannequin of claim 23, wherein the at least one cover, with the at least one electronic visual display connected thereto, is removable from the patient simulating mannequin.

27-45. (canceled)

46. A method for modeling at least one eye of a patient simulating mannequin, the method comprising:
determining an eye state control parameter of the patient simulating mannequin, the eye state control parameter being at least one of a modeled physiological state of the patient simulating mannequin, a location of a trainee relative to the patient simulating mannequin, and an intensity of ambient light;
displaying at least one image of the at least one eye on at least one electronic visual display based on the eye state control parameter; and
displaying at least one other image of the at least one eye on the at least one electronic visual display based on at least a change of the eye state control parameter.

47. The method of claim 46, wherein:
the at least one electronic visual display includes a left electronic visual display and a right electronic visual display;
the at least one eye includes a left eye and a right eye;
the left electronic visual display displays images of the left eye; and
the right electronic visual display displays images of the right eye.

48. The method of claim 46, wherein displaying at least one image of at least one eye includes displaying at least one image of at least one of a pupil, an iris and a sclera of the at least one eye; and
displaying at least one other image of the at least one eye includes displaying the at least one of the pupil, iris and sclera of at least one of a different color, position and shape relative to the image of the at least one eye.

49. The method of claim 46, wherein the at least one image of the at least one eye and the at least one other image of the at least one eye include at least a plurality of healthy eye images and a plurality of eye images displaying a trauma.

50. The method of claim 47, wherein the at least one image of the at least one eye includes at least one image of at least one eye and eyelid.

51. The method of claim 50, wherein the at least one image of eye and eyelid includes images of different eyelid positions.

52-54. (canceled)
